(19) United States
(12) Patent Application Publication
(10) Pub. No.: US 2018/0145402 A1
(43) Pub. Date: May 24, 2018

(54) VEHICLE ROOF APPARATUS

(71) Applicant: AISIN SEIKI KABUSHISIKI KAISHA, Kariya-shi (JP)

(72) Inventor: Naoto KAMIOKU, Kariya-shi (JP)

(73) Assignee: AISIN SEIKI KABUSHISIKI KAISHA, Kariya-shi (JP)

(21) Appl. No.: 15/704,303

(22) Filed: Sep. 14, 2017

(30) Foreign Application Priority Data
Nov. 21, 2016 (JP) 2016-225631

(51) Int. Cl. H01Q 1/32; B60J 7/043; B60J 7/22; B62D 25/06; H01Q 1/12

(52) U.S. Cl. CPC H01Q 1/3275; B60J 7/043; B62D 29/007; B62D 25/06; H01Q 1/1214; B60J 7/22

(57) ABSTRACT

A vehicle roof apparatus on which an antenna main body is configured to be placed includes: an outer panel including a panel portion configured to cover a roof of the vehicle, and a cover portion integrally formed with the panel portion and raised toward an outside of the panel portion, in which an accommodating chamber that is configured to accommodate the antenna main body and that is opened toward an inside of the panel portion is provided in the cover portion.

### CROSS REFERENCE TO RELATED APPLICATIONS

This application is based on and claims priority under 35 U.S.C. § 119 to Japanese Patent Application 2016-225631, filed on Nov. 21, 2016, the entire contents of which are incorporated herein by reference.

### TECHNICAL FIELD

This disclosure relates to a vehicle roof apparatus.

### BACKGROUND DISCUSSION

There has been known a vehicle roof apparatus in the related art in which an antenna main body is disposed outside a vehicle. In some of such vehicle roof apparatuses, a hole portion is formed in order to electrically connect the antenna main body disposed outside the vehicle to an electronic device disposed inside the vehicle (see e.g., JP20156154104A (Reference 1)).

However, in the vehicle roof apparatus described above, when sealing with the antenna main body is insufficient, foreign matters such as water or dust may infiltrate into the antenna main body. Further, the foreign matters infiltrating into the antenna main body may infiltrate into the interior of the vehicle through the hole portion.

Thus, a need exists for a vehicle roof apparatus which is not susceptible to the drawback mentioned above.

### SUMMARY

A vehicle roof apparatus according to an aspect of this disclosure on which an antenna main body is configured to be placed includes an outer panel including a panel portion and a cover portion integrally formed with the panel portion and raised toward an outside of the panel portion. An accommodating chamber that is configured to accommodate the antenna main body and that is opened toward an inside of the panel portion is provided in the cover portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an external view of a vehicle roof apparatus attached to a vehicle;

FIG. 2 is an exploded perspective view of the vehicle roof apparatus;

FIG. 3 is an external view of an outer panel, which illustrates a sealing state of the outer panel; and

FIG. 4 is a sectional view illustrating a state where an antenna main body is accommodated in an accommodating chamber.

### DETAILED DESCRIPTION

Hereinafter, an exemplary embodiment of a vehicle roof apparatus disclosed here will be described with reference to drawings.

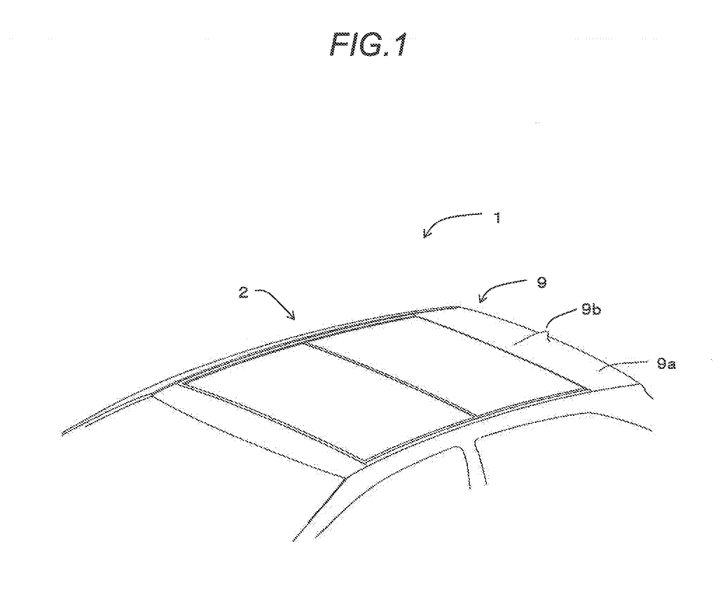

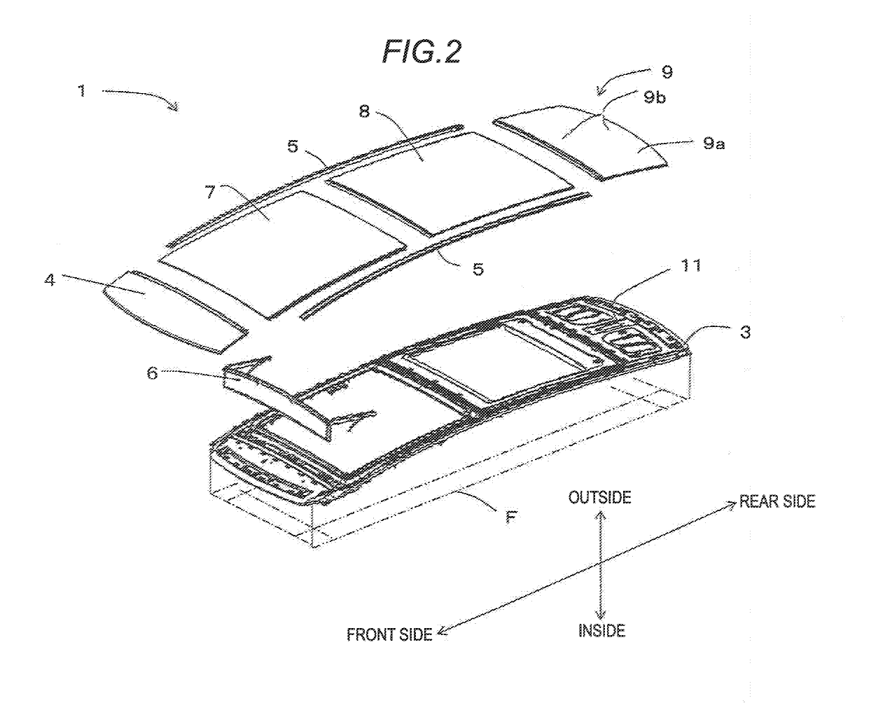

As illustrated in FIG. 1, a vehicle roof apparatus 1 according to the exemplary embodiment is attached to a vehicle roof 2. As illustrated in FIG. 2, the vehicle roof apparatus 1 includes a front panel 4, a deflector 6, a side garnish 5, a first sunroof panel 7, a second sunroof panel 8, an outer panel 9, and a base panel 3.

Specifically, as illustrated in FIG. 2, the vehicle roof apparatus 1 includes the base panel 3 that is mainly made of a steel material or the like, and is connected to a vehicle frame F to cover the entire vehicle roof 2. The base panel 3 not only functions as an attaching base that attaches other portions of the vehicle roof apparatus 1 to the vehicle roof 2, but also serves to secure the rigidity of the vehicle roof 2 by being connected to the vehicle frame F. The base panel 3 is made of a steel material or the like, and then function to secure a dielectric constant in an antenna main body 12 to be described below.

As illustrated in FIG. 2, the vehicle roof apparatus 1 includes the front panel 4 attached to the front side of the vehicle roof 2, and the deflector 6 extending in the vehicle width direction and standing up. The deflector 6 serves to reduce the entrainment of wind from the exterior of the vehicle into the interior of the vehicle, and to suppress the wind noise. A pair of side garnishes 5 extending in the vehicle longitudinal direction are provided at both ends in the vehicle width direction so as to improve the appearance design of the vehicle.

Further, the vehicle roof apparatus 1 includes the first sunroof panel 7 and the second sunroof panel 8. The first sunroof panel 7 and the second sunroof panel 8 are made of a material having transparency such as glass so as to show a passenger the view of the top of the vehicle and to provide a feeling of openness to the passenger. In the portion where the first sunroof panel 7 and the second sunroof panel 8 are fitted, the base panel 3 supports only the outer periphery portions of the first sunroof panel 7 and the second sunroof panel 8, and other portions are opened toward the inside of the vehicle. Thus, the base panel 3 does not disturb the lighting or feeling of openness brought into the passenger compartment of the vehicle through the first sunroof panel 7 and the second sunroof panel 8.

Then, the vehicle roof apparatus 1 includes, at the rear side thereof, the outer panel 9 made of a resin, a metal or the like. As illustrated in FIGS. 1 and 2, the outer panel 9 includes a panel portion 9a that covers the rear portion of the vehicle roof 2, and a cover portion 9b integrally formed with the panel portion 9a.

The panel portion 9a covers, at the rear side of the vehicle, the vehicle roof 2 in the vehicle width direction. Meanwhile, the cover portion 9b is attached at substantially the center of the panel portion 9a in the vehicle width direction in the exemplary embodiment, and is raised toward the outside of the panel portion 9a. The cover portion 9b is formed in a shape of a so-called shark fin antenna, and has a substantially triangular section.

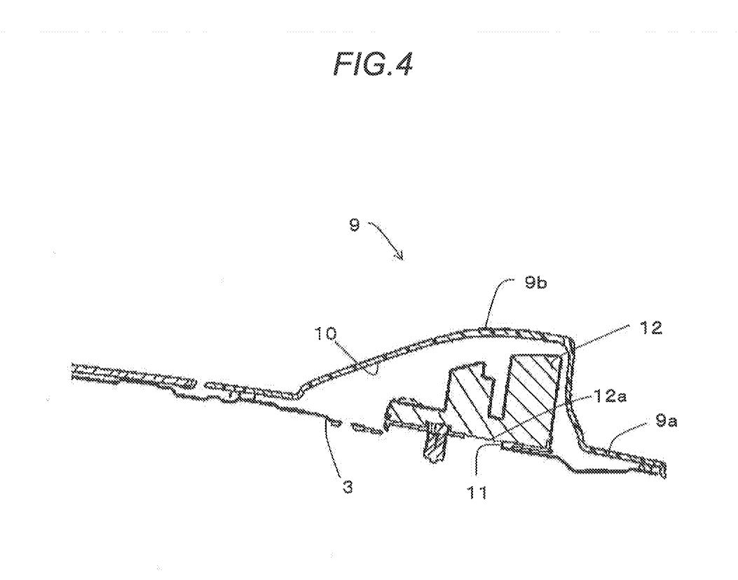

As illustrated in FIG. 4, an accommodating chamber 10 that is opened toward the inside of the panel portion 9a and that is configured to accommodate the antenna main body 12 is provided in the cover portion 9b. The shapes and sizes of the accommodating chamber 10 and the cover portion 9b are changed according to the shape and size of the antenna main body 12 accommodated in the accommodating chamber 10.

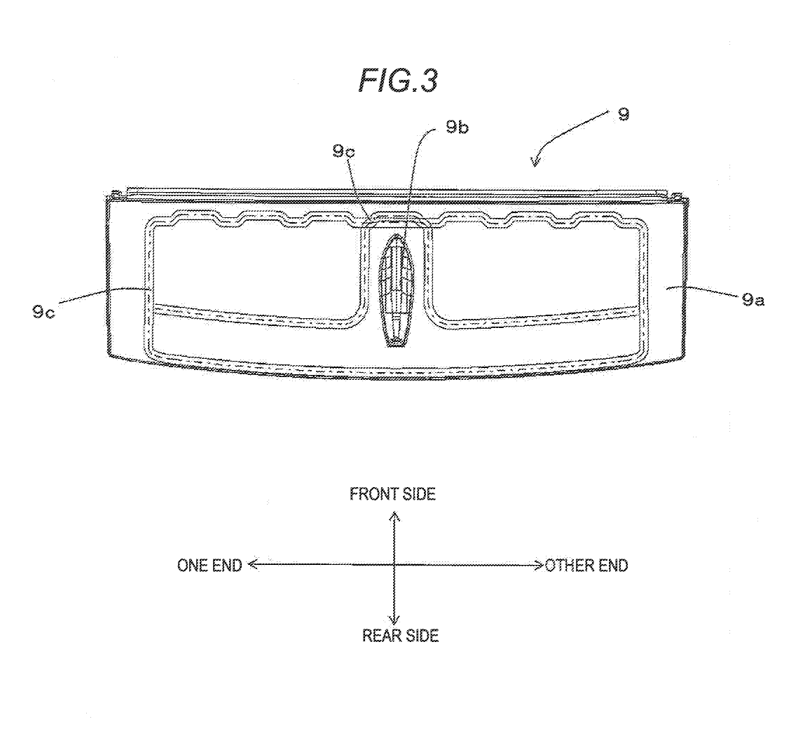

Here, the sealing between the outer panel 9 and the base panel 3 will be described with reference to FIG. 3. As illustrated in FIG. 3, the outer panel 9 and the base panel 3 have a seal portion 9c in which an outer periphery portion of the outer panel 9 and the base panel 3 is sealed through an adhesive such as urethane. The outer panel 9 has a large area in the vehicle width direction, and thus is subjected to a large wind pressure during traveling of the vehicle. In order to secure sealing that may withstand the large wind pressure, an adhesive such as urethane may be employed in adhesion between the outer panel 9 and the base panel 3.

Further, at substantially the center in the front-rear direction of the outer panel 9, sealing is made from one end to the other end of the outer panel 9 like in the seal portion 9c. In the sealing, the outer panel 9 and the base panel 3 are sealed such that the sealing surrounds the front portion of the cover portion 9b in the vehicle longitudinal direction. This serves to reinforce the sealing at the outer periphery portion of the outer panel 9. Specifically, since the cover portion 9b is raised to the upper side of the vehicle, a larger wind pressure may be applied to, particularly, the front portion of the cover portion 9b during traveling of the vehicle. Thus, it is necessary to particularly strongly seal the front portion of the cover portion 9b in the vehicle longitudinal direction, The front portion of the cover portion 9b is sealed with a reinforcement so as to cope with and withstand a high wind pressure.

As illustrated in FIG. 4, a substantially rectangular communication hole 11 is formed in the base panel 3 so that the accommodating chamber 10 is communicated with a space inside the vehicle. The communication hole 11 is formed in the base panel 3 such that when the antenna main body 12 is accommodated in the accommodating chamber 10 of the cover portion 9b, the antenna main body 12 placed in the base panel 3 may be attached from the inside of the vehicle through the communication hole 11.

Further, as illustrated in FIG. 4, the antenna main body 12 is placed in the base panel 3 connected to the vehicle frame F. Specifically, the antenna main body 12 is fixed to the base panel 3 when a bottom surface 12a of the antenna main body 12 abuts on the base panel 3 within the accommodating chamber 10 of the cover portion 9b. Compared to the case where the antenna main body 12 is attached to the cover portion 9b or the like, in the case where the antenna main body 12 is attached to the base panel 3, it is possible to stably attach the antenna main body 12 even when the antenna main body 12 is increased in size.

The antenna main body 12 includes an antenna element (not illustrated) that contributes to transmission and reception of radio waves, a cable (not illustrated) that connects the antenna element to a receiver placed in the vehicle, and the like.

According to the exemplary embodiment, the following effects may be obtained.

(1) In the exemplary embodiment, the cover portion 9b including the accommodating chamber 10 that is configured to accommodate the antenna main body 12 is integrally formed with the panel portion 9a that covers the rear portion of the vehicle roof 2. Thus, the antenna main body 12 is attached from the inside of the vehicle, and does not need to be attached from the outside of the vehicle. Accordingly, rain or the like is suppressed from infiltrating into the vehicle from the outside of the vehicle through an attachment portion of the antenna main body 12.

(2) The antenna main body 12 is attached to the base panel 3 connected to the vehicle frame F. Thus, even when the antenna main body 12 is increased in size, the antenna main body 12 may be stably placed.

(3) The communication hole 11 through which the accommodating chamber 10 in which the antenna main body 12 is to be provided and the space inside the vehicle communicate with each other is formed in the base panel 3. When the communication hole 11 has such a shape and size that the antenna main body 12 may be inserted through the communication hole 11, the antenna main body 12 may be separately attached. That is, in a state where the vehicle roof apparatus 1 except for the antenna main body 12 is assembled, the antenna main body 12 may be separately attached.

(4) The outer panel 9 and the base panel 3 are sealed such that the sealing surrounds the front portion of the cover portion 9b in the vehicle longitudinal direction. Accordingly, even when a large wind pressure is applied to the cover portion 9b that is raised toward the outside of the panel portion 9a during traveling of the vehicle, the outer panel 9 is not detached from the base panel 3, and a high sealing property is ensured.

In the exemplary embodiment, the cover portion 9b is provided at substantially the center of the outer panel 9 in the width direction of the vehicle roof 2, but the embodiment disclosed here is not limited. One or more cover portions 9b may be provided at the end portion of the vehicle roof 2. An adhesive such as urethane may be employed in adhesion between the outer panel 9 and the base panel 3, but sealing may be made by a double-sided tape or the like depending on conditions. The substantially cross section of the cover portion 9b may be substantially semicircular or substantially rectangular.

The shape and size of the communication hole 11 formed in the base panel 3 may be arbitrarily changed according to the shape and size of the antenna main body 12. For example, the shape of the communication hole 11 may be substantially circular, substantially elliptic or substantially triangular.

A vehicle roof apparatus according to an aspect of this disclosure in which an antenna main body is to be placed includes an outer panel including a panel portion and a cover portion integrally formed with the panel portion and raised toward an outside of the panel portion. An accommodating chamber that is configured to accommodate the antenna main body and that is opened toward an inside of the panel portion is provided in the cover portion.

With this configuration, the accommodating chamber configured to accommodate the antenna main body is provided in the cover portion integrally formed with the outer panel, and thus the antenna main body is accommodated from the inside of the vehicle. In other words, the antenna main body does not need to be attached from the outside of the vehicle. That is, since it is not necessary to form a hole through which the antenna main body is attached in the roof apparatus, foreign matters may be suppressed from infiltrating into the vehicle.

In the roof apparatus, the outer panel may further include a base panel connected to a vehicle frame.

With this the configuration, the antenna main body is provided in the base panel connected to a frame of the roof apparatus. Thus, compared to the case where the antenna main body is attached to the outer panel, rigidity in the attachment of the antenna main body is secured, and even a large-sized antenna main body may be stably attached.

In the roof apparatus, a communication hole through which the accommodating chamber and a space inside the vehicle communicate with each other may be formed in the base panel.

With this the configuration, when the communication hole has such a size that the antenna main body may be inserted through the communication hole, the antenna main body may be attached to the roof apparatus through the communication hole formed in the base panel. That is, through a separate process from a process of assembling the outer panel with the roof panel, the antenna main body may be mounted.

The roof apparatus may further include a seal portion that seals a gap between the outer panel and the base panel. The seal portion may be provided to surround a front portion of the cover portion in a vehicle longitudinal direction.

With this configuration, the outer panel that is subjected to a large wind pressure during traveling of the vehicle, particularly, the front portion of the cover portion in the vehicle longitudinal direction that may be subjected to a large wind pressure is sealed, so that the outer panel may be suppressed from being detached due to the large wind pressure occurring in the cover portion during the traveling of the vehicle.

The principles, preferred embodiment and mode of operation of the present invention have been described in the foregoing specification. However, the invention which is intended to be protected is not to be construed as limited to the particular embodiments disclosed, Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle roof apparatus on which an antenna main body is configured to be placed, the roof apparatus comprising:
an outer panel including
a panel portion configured to cover a roof of the vehicle, and
a cover portion integrally formed with the panel portion and raised toward an outside of the panel portion,
wherein an accommodating chamber that is configured to accommodate the antenna main body and that is opened toward an inside of the panel portion is provided in the cover portion.

2. The vehicle roof apparatus according to claim 1,
wherein the outer panel further includes a base panel configured to be connected to a vehicle frame.

3. The vehicle roof apparatus according to claim 1,
wherein a communication hole through which the accommodating chamber and a space inside the vehicle communicate with each other is formed in a base panel. 4, The vehicle roof apparatus according to claim 1, further comprising:
a seal portion that seals a gap between the outer panel and a base panel,
wherein the seal portion is provided to surround a front portion of the cover portion in a vehicle longitudinal direction.
